(19) United States
(12) Patent Application Publication
(10) Pub. No.: US 2018/0232508 A1
(43) Pub. Date: Aug. 16, 2018

(54) LEARNING ENGINES FOR AUTHENTICATION AND AUTONOMOUS APPLICATIONS

(71) Applicant: The Trustees of Columbia University in the City of New York, New York, NY (US)

(72) Inventor: Eren Kursun, New York, NY (US)

(21) Appl. No.: 15/892,996

(22) Filed: Feb. 9, 2018

Related U.S. Application Data
(60) Provisional application No. 62/457,541, filed on Feb. 10, 2017.
(60) Provisional application No. 62/524,421, filed on Jun. 23, 2017.

(51) Int. Cl. G06F 21/32; G06N 7/02

(52) U.S. Cl. CPC G06F 21/32; G06N 7/02

(57) ABSTRACT

Disclosed are methods, systems, devices, apparatus, media, and other implementations, including a method that includes obtaining user-related data from a plurality of input sources, deriving multiple time-dependent authentication metrics based on the user-related data from the plurality of input sources, applying at least one of the derived multiple time-dependent authentication metrics to a learning authentication engine configured to authenticate an authorized user based on multiple inputs and correlations between at least some of the multiple inputs, and generating an authentication signal in response to a determination, by the learning authentication engine, that the derived multiple time dependent authentication metrics correspond to the authorized user.

### CROSS-REFERENCE TO RELATED APPLICATIONS

This application claims the benefit of U.S. Provisional Application No. 62/457,541, entitled “PERSONALIZED PROCESSING UNIT BASED AUTHENTICATION AND SECURE PROCESSING FOR HIGH SECURITY APPLICATIONS” and filed Feb. 10, 2017, and U.S. Provisional Application No. 62/524,421, entitled “NEUROMORPHIC PROCESSING SYSTEM AND METHOD FOR ENERGY EFFICIENT, SECURE AUTONOMOUS APPLICATIONS” and filed Jun. 23, 2017, the contents of which are incorporated by reference in their entireties.

### BACKGROUND

Various applications depend on voluminous amounts of data to execute correctly or securely. An example of such a system is an authentication system. Password-based authentication systems face serious challenges (due, in part, to the recent mobile device trends). An average web user is reported to have ˜40 passwords, with the numbers being much higher for certain demographics and geographies. Biometric data is thus becoming an important method for authentication (commonly used in banking applications, identity management, etc.), but software-based implementations of biometrics authentication technologies carry high risk of spoofing and biometrics data theft. Stolen single mode biometrics data (e.g. iris, fingerprint, etc.) can be repeatedly used for authentication.

In another example, autonomous systems, such as self-driving vehicles, are capable of sensing the environment and navigating without human input. In the case of self-driving vehicles, technology and automotive industry leaders have presented various proof of concepts and implementations in recent year. Self-driving/autonomous vehicles have been reported to have better safety characteristics compared to human drivers. According to recent statistics first fatal accident reported in total of 130 Million Miles of driving. Other reports highlight higher minor accident rate (˜2×) due to the inability to adopt to minor violations in traffic.

### SUMMARY

In some variations, a method is provided that includes obtaining user-related data from a plurality of input sources, deriving multiple time-dependent authentication metrics based on the user-related data from the plurality of input sources, applying at least one of the derived multiple time-dependent authentication metrics to a learning authentication engine configured to authenticate an authorized user based on multiple inputs and correlations between at least some of the multiple inputs, and generating an authentication signal in response to a determination, by the learning authentication engine, that the derived multiple time dependent authentication metrics correspond to the authorized user.

Embodiments of the method may include at least some of the features described in the present disclosure, including one or more of the following features.

The method may further include periodically re-deriving the multiple time-dependent authentication metrics based on incoming time-varying user-related data from at least some of the plurality of input sources, and periodically generating subsequent authentication signals in response to determining the periodically re-derived multiple time-dependent authentication metrics correspond to the authorized user.

Obtaining the user-related data comprises obtaining the user-related data via one or more of, for example, a wearable device, a mobile device, and/or a remote wireless device. The user-related data may include one or more of, for example, user-related biometric data, user-related physiological data, user-related behavioral data, and/or user-related location data.

Obtaining the user-related data comprises obtaining one or more of, for example, face image data for a person, eye features data for the person, movement pattern data for the person, keystroke pattern data for the person, signature data for the person, voice data for the person, speech data for the person, geometry data, heart signal data, body temperature data, skin resistance data, pH level data, and/or blood sugar data.

The learning authentication engine may include a neuromorphic-based learning engine trained using respective user-related data from the multiple inputs from the authorized user.

The learning authentication engine may be configured to implement fuzzy matching processing.

the authentication signal may be configured to activate one or more remote systems such that without the authentication signal, activity of the one or more remote systems is inhibited.

The one or more remote systems may include, for example, a mobile phone, a remote financial server, and/or a medical server storing medical information.

The method may further include generating data tokens in response to the determination, by the learning authentication engine, that the derived multiple time dependent authentication metrics correspond to the authorized user, and including the data tokens with data records associated with the authorized user so as to mark the data records and inhibit unauthorized use of the data records associated with the authorized user.

The learning authentication engine may include multiple neural network units to receive respective ones of multiple authentication data streams, with at least one of the respective ones of the multiple authentication data streams including the at least one of the derived multiple time-dependent authentication metrics. The method may further include periodically varying inputs of the multiple neural network units to switch the respective ones of the multiple authentication data streams being directed to the inputs of the multiple neural network units.

In some variations, a personalized processing unit is provided that includes a communication module configured to receive user-related data from a plurality of input sources, a learning authentication engine configured to authenticate an authorized user based on multiple inputs and correlations between at least some of the multiple inputs, and a processor-based controller, communicatively coupled to the communication module and to the learning authentication engine. The controller is configured to derive multiple time-dependent authentication metrics based on the user-related data from the plurality of input sources, apply at least one of the derived multiple time-dependent authentication metrics to the learning authentication engine, and generate an authentication signal in response to a determination, by the learning authentication engine, that the derived multiple time dependent authentication metrics correspond to the authorized user.

Embodiments of the personalized processing unit may include at least some of the features described in the present disclosure, including at least some of the features described above in relation to the method, as well as one or more of the following features.

The controller may further be configured to periodically re-derive the multiple time-dependent authentication metrics based on incoming time-varying user-related data from at least some of the plurality of input sources, and periodically generate subsequent authentication signals in response to determining the periodically re-derived multiple time-dependent authentication metrics correspond to the authorized user.

In some variations, an additional method is provided for neuromorphic processing for an autonomous system. The method includes receiving real-time data from multiple input sources, with each of the multiple input sources respectively associated with one of a plurality of data types, and directing data associated with the plurality of data types to respective processing columns, each of the processing columns comprising a trainable deep neural network engine configured to produce corresponding output. The additional method further includes fusing outputs from the processing columns to generate a plurality of action options representative of actions performable by the autonomous system, each of the action options associated with respective metrics, with the respective metrics comprising action risk metrics, and selecting one of the action options based, at least in part, on the respective metrics associated with the plurality of action options.

Embodiments of the additional method may include at least some of the features described in the present disclosure, including at least some of the features described above in relation to the first method and the personalized processing unit, as well as one or more of the following features.

The multiple input sources may include one or more of, for example, a video input source, an audio input source, and/or an RF input source.

The additional method may further include applying at least the selected one of the action options to further train the trainable neural network engine of the each of at least one of the processing columns.

In some variations, a neuromorphic-processing-based autonomous system is provided. The system includes a plurality of processing columns configured to process respective data corresponding to at least one of a plurality of data types, each of the plurality of processing columns including a trainable deep neural network engine configured to produce corresponding output, and a global controller coupled to the plurality of processing columns. The global controller is configured to receive real-time data from multiple input sources, with each of the multiple input sources respectively associated with one of the plurality of data types, and direct data associated with the plurality of data types to the respective ones of the plurality of processing columns. The global controller is further configured to fuse outputs from the processing columns to generate a plurality of action options representative of actions performable by the autonomous system, with each of the action options associated with respective metrics, with the respective metrics comprising action risk metrics, and select one of the action options based, at least in part, on the respective metrics associated with the plurality of action options.

Embodiments of the neuromorphic-processing-based autonomous system may include at least some of the features described in the present disclosure, including at least some of the features described above in relation to the methods and the personalized processing unit, as well as one or more of the following features.

The system may further include one or more of, for example, a video input sensor to generate video data provided to the video input source, an audio sensor to generate audio data provided to the audio input source, and/or an RF receiver to receive RF data provided to the RF input source.

Other features and advantages of the invention are apparent from the following description, and from the claims.

### BRIEF DESCRIPTION OF THE DRAWINGS

These and other aspects will now be described in detail with reference to the following drawings.

FIG. 1 is a block diagram of an example architecture for a Personalized Processing Unit (PPU) to implement authentication operations.

FIG. 2 includes diagrams illustrating a process to implement a Recursive Binary Neural Network (RBNN) learning model that may be used with the system of FIG. 1.

FIG. 3 is a flow diagram to implement an authentication and secure processing procedure.

FIG. 4 is a flow diagram of an example procedure to make authentication requests and received response thereto.

FIG. 5 is a flowchart of an example procedure to perform authentication operations.

FIG. 6 is a block diagram of a cognitive processing system to implement an autonomous application.

FIG. 7 is a flow diagram of a procedure to control an autonomous system.

FIG. 8 is a flowchart of a procedure for neuromorphic processing for an autonomous system.

FIG. 9 is a schematic diagram of an example device which may be used to implement an authentication device or a device to control autonomous applications.

Like reference symbols in the various drawings indicate like elements.

### DESCRIPTION

Described herein are systems, devices, methods, products, media, and other implementations that incorporate one or more learning engines (e.g., neural networks) to process multiple data streams (including biometric data, motion data from multiple sources, etc.) in order to facilitate decision making processes that integrate and rely on such multiple data streams.

### Authentication Systems

In some examples, systems, devices, apparatus, methods, computer program products, media, and other implementations are provided that include a personalized processing unit, or PPU, which may be housed as a personal independent device, or constitute part of some other system (e.g., integrated on a wearable device, such as smart watches, or smartphones). The implementations described herein rely on dynamically changing composite biometrics, and run-time data, for secure and private authentication of users without requiring user name and passwords, and for secure and private processing of highly sensitive data for high security applications such as medical applications, banking, identification, etc. The implementations described herein also provide a novel technique to digitally stamp and tokenize data so that only authorized applications can process the data under specified rules. Furthermore, the personalized processing unit described herein incorporates a new procedure to control slave processing units, processes and data to fully control the personalized data processing ecosystems.

In some embodiments, a hardware PPU implementation, to generate embedded composite user-related data, includes: (i) permanent user-related data (e.g., biometric data) storage (which may have been used to train an authentication learning engine and for subsequent user authentication), (ii) a composite dynamic user-related data unit, and (iii) the authentication learning engine, which may be realized as a neuromorphic-based learning engine (e.g., cross-wire or cross-bar based neuromorphic chip) and/or may be implemented as a fuzzy matching authentication engine. The type and content of stored user-related data should not be accessible at the software level or by applications (so that data is protected from attackers). To mitigate the risk of data spoofing, the PPU uses composite and linked user-related data (i.e., no pure modality data is used). For example, instead of using fingerprints data, iris data, face biometrics data, etc., interlinked biometrics data may be taken in relation to each other with specialized high level tokens. Thus, the PPU may be implemented so that it can learn, and subsequently determine, the existence of correlation between different data types (e.g., identify certain facial expressions, heart rate, and so on, that occur while a user is speaking in a certain pitch and tone). User-related data (e.g., biometrics) modality also shifts weight dynamically (use biometrics based on face+iris data, but within time t, move to using face+voice by gradually shifting fusion fudge factors). By dynamically shifting weights of received input, it becomes more difficult for external parties (e.g., spoofers) to determine which modality or metric combination is being used. The PPU also determines links and correlations based on historical data, other personal information data, and uses those determined links (which may be determined through a neural net realizations) for anomaly detection. Thus, composite multi-modal user-related data is stored and used for authentication in combination with history and personal information data.

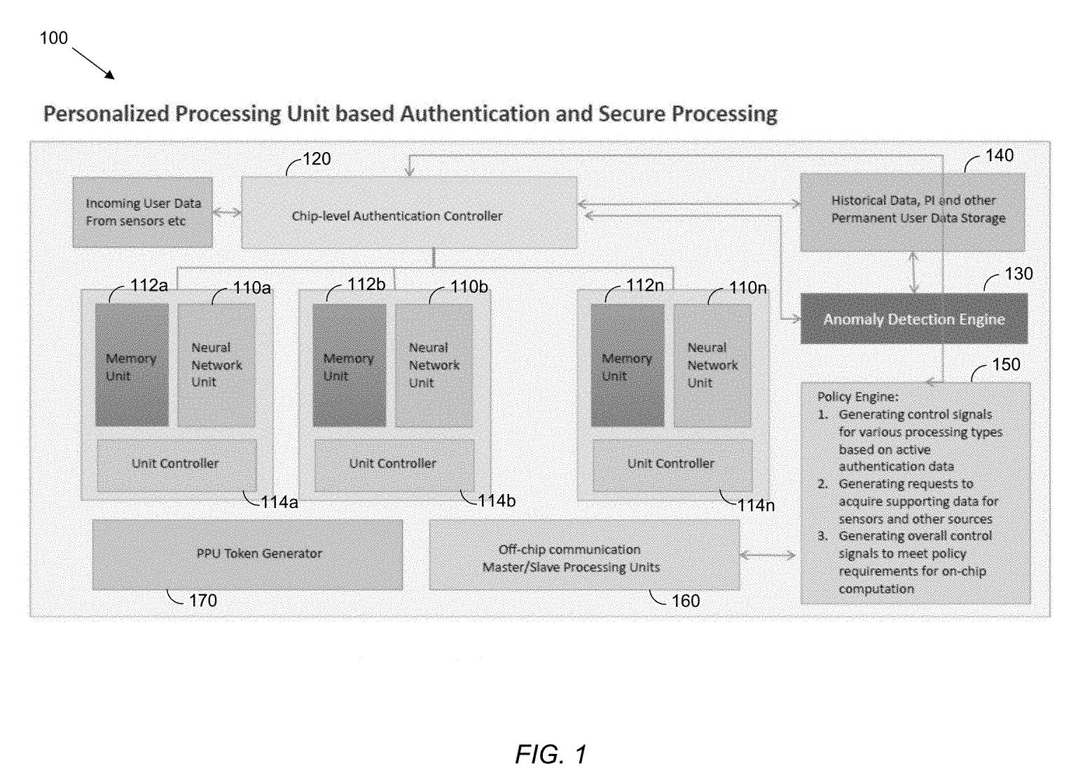

With reference to FIG. 1, a block diagram of an example architecture for a Personalized Processing Unit (PPU) 100 is provided. The PPU 100 may be implemented on a personal user device, which may be a smartphone (e.g., as a process or application running on the processor of the smartphone or other type of cellular personal device) or a dedicated token or miniature personal device that can accept or collect biometric data and provide output responsive to a determination of whether the input data authenticates a user (i.e., a determination that the input data is indicative that the source of the data correspond to the user being authenticated). The PPU 100 includes one or more 110a-n neural network units (each of which may be dedicated for a different biometric input), which, in combination with an authentication controller 120 and an anomaly detection engine 130, may be configured to determine whether incoming user data (e.g., currently provided biometric data from some user) corresponds to an authorized user (which may be one of several users enrolled on the PPU). The neural network units 110a-n are coupled to respective memory units 112a-n and unit controllers 114a-n. The memory units 112a-n may be configured to store training data, as well as recently acquired real-time data (corresponding to the data that needs to be authenticated) that may be used for dynamic adaptation of the corresponding neural network (i.e., as a recent data point that may or may not have been authenticated; authentication of a recent real-time point can be used to further configure the corresponding neural network to respond more favorably to similar subsequently acquired data). The respective controller units 114a-n may be processor-based controller (actual dedicated hardware processors, or processor-threads allocated and controlled via a central processor for the PPU unit).

Neural networks are in general composed of multiple layers of transformations (multiplications by a “weight” matrix), each followed by a linear or nonlinear function. The linear transformations are learned during training by making small changes to the weight matrices that progressively make the transformations more helpful to the final classification task. The layered network may include convolutional processes which are followed by pooling processes along with intermediate connections between the layers to enhance the sharing of information between the layers.

Various learning engines may be used to implement the classification processes of the PPU 100 (e.g., classification processes to generate metrics indicative of the degree or level of confidence that an input stream corresponds data from a particular user). Examples of learning engines include neural network-based engines, support vector machines (e.g., one implementing a non-linear radial basis function (RBF) kernel), engines based on implementations of a k-nearest neighbor procedure, engines implementing tensor density procedures, engines implementing hidden Markov model procedures, etc. Examples of neural networks include convolutional neural network (CNN), recurrent neural networks (RNN), etc. Convolutional layers allow a network to efficiently learn features that are invariant to an exact location in a data set (e.g., image data) by applying the same learned transformation to subsections of the entire data set.

Another example of a learning engine architecture that may be used in conjunction with, for example, the neural network units 110a-n and/or the anomaly detection engine 130 of the PPU 110 is that of Recursive Binary Neural Network (RBNN), which is suitable for on-chip data storage during training. The RBNN architecture/model is based on the process of training of a neural network, weight binarization, and recycling storage of non-sign-bit portion of weights to add more weights to enlarge the neural network for performance improvement. The process is recursively performed until either the accuracy stop improving, or all the storage on a chip is used up. In the RBNN model, sign bits are used for multiply-and-accumulate (MAC) operations to reduce computational complexity. After training and binarization of weights (keeping only sign bits), the data storages that are used to store non-sign bits of weights are recycled to add more multi-bit trainable weights to the neural network. This new network is then trained to have both the binarized non-trainable weights and the newly-added trainable weights. This process is performed recursively, which makes the neural networks larger and more accurate but using the same amount of data storage for weights.

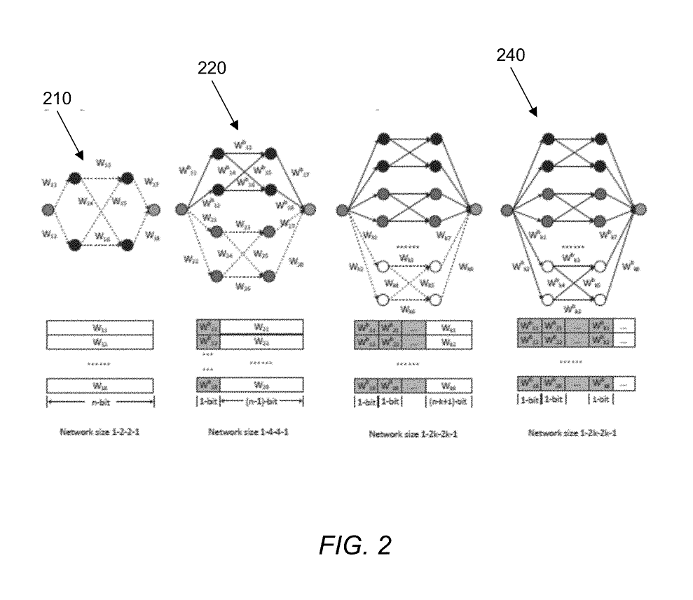

With reference to FIG. 2, an example process to implement an RBNN learning model with a multi-layer, fully-connected neural network, is shown. FIG. 2 provides an example of an initial neural network 210 with one input, two sets of two hidden layers, and one output neurons. The neural network 210 has and eight weights, each of which comprises n bits. This 1×2×2×1 network can be trained using, for example, a conventional back-propagation training algorithm. After the training procedure is completed, the bits are discarded except for the sign bits in each weight (binarization), resulting in a 1×2×2×1 trained network having binary weights (corresponding to a trained BNN). In a second iteration of the training (illustrated in enlarged network 220 of FIG. 2), the storage is recycled so that it is used to store the n−1 non-sign bits of weights in the 1×2×2×1 network. Using this data storage, eight additional weights (W₂₁ to W₂₈) are added to the trained BNN, expanding the network to a 1×4×4×1 configuration (corresponding to the resultant neural network 222). In this enlarged BNN 220, each of the newly-added weights is n−1 bits. In other words, the enlarged BNN 220 comprises of one trained BNN that has eight weight (W^{b}₁₁ to W^{b}₁₈) that are trained (marked as solid lines in the diagrams of FIG. 2) and one incremental BNN with eight weights (W₂₁ to W₂₈) that are under-trained (n−1 bits, depicted as dash lines in the diagrams of FIG. 2). The incremental BNN is trained together with the trained BNN but only the weights of incremental BNN are updated.

The same process of binarization and recycling is repeated. In every iteration, the enlarged BNN integrates 8 more weights, and the bit-width of newly-added plastic weights in the incremental BNN is reduced by one. At the k iterations, the trained BNN has 8·(k−1) neurons and the plastic weights have (n−k+1) bit-width. After the k^{th} training is finished, a resultant neural network 240 becomes a 1×2k×2k×1 network with 8·k binary weights. This network has k times more weights than the first 1×2×2×1 network. However, the data storage of weights remains the same, scaling the storage requirement per weight to n/k (=4·n/4·k), which is k times smaller than that of the first network. Thus, the proposed RBNN can either achieve better classification accuracy (achieved by the larger number of weights), with the same amount of weight storage, or reduce weight storage requirement for the same classification accuracy level. Thus, in an RBNN learning model, the learning engine is subjected to an initial BNN training (e.g., using a conventional BNN training method), followed by a bit-width reduction to reduce the bit-width of at least some (and in some embodiments, all) the synaptic weights. This is followed by training an incremental BNN configuration using the previously trained BNN, and computing a performance evaluation metric representative of the performance of the trained enlarged (incremented) BBN. If a stop criterion has been met (the evaluation metric satisfies a pre-determined requirement), the training procedure is terminated. Otherwise, the process of bit-reduction, incremental BNN training, and performance evaluation is repeated.

Turning back to FIG. 1, as noted, the PPU 100 further includes the anomaly detection engine 130 configured to implement continuous anomaly detection on the input streams as well as on historical data stored on data storage unit 140. In some embodiments, the anomaly detection engine may be implemented as a learning engine(s) which may be configured to process metrics generated from input streams, or outputs of the learning engines 110a-n, and may thus be adapted to recognize correlations between input streams associated with a particular enrolled used. As noted, the incoming data may be weighed according to time-dependent functions (implementing random or pseudorandom functions) to create metrics (e.g., composite metrics based on data from multiple input sources) that can then be evaluated via the neural network units 110a-n and/or via the anomaly detection engine 130 to determine if the incoming data corresponds to the authorized user.

In response to a determination that the incoming data corresponds to an authorized user, control signals (authentication signals) may be provided to remote systems to activate or actuate them. Depending on the sensitivity or importance (as may be determined by a policy engine 150 of the PPU) of authenticating a user for a particular system (e.g., a financial server system may require a high degree of confidence in the authentication process before executing a transaction), additional information may be requested from the particular system. Furthermore, in some embodiments, periodical (e.g., every 1 second, every 5 seconds, etc.) fresh authentication signals (based on new data points from the input sources) may need to be provided to the particular system requiring the authentication signal(s). In some embodiments, an off-chip communication Master/Slave Processing Units 160 (depicted in FIG. 1) may be used to communicate authentication/control signals, and/or to send requests for further information.

As also illustrated in FIG. 1, a PPU Token Generator 170 may be used to generate tokens (e.g., upon authenticating a user) that are included/embedded in data records associated with the authenticated users (thus confirming authenticity of those records). For example, the token could be based on a deterministic function applied to some combination of data derived by the neural networks 110a-n and/or their respective metrics. Subsequently, accessing the tokenized records may be done only by authorized users, as may be determined according to the authorized users' authenticated input data (e.g., biometric data). For example, a user's biometric data may be used to generate authentication signals (e.g., via a process that is similar to the authentication process performed by the PPU 100), and to determine the closeness of the tokens to previously generated token embedded or otherwise included in a data record. In some embodiments, the PPU 100 may be the device performing the process to generate a token to be matched to a previously generated token embedded in a data record.

The implementations described herein (including the example implementations of FIG. 1) allow identifying and using, for authentication purposes, previously unestablished features or relationships (i.e., through use of a learning engine). In some embodiments, the implementations described herein are configured to allow dynamically switching the input sources and authentication engines to prevent spoofers from mimicking the corresponding data streams. In some embodiments, the PPU may be configured to vary the level, accuracy and type of input data being acquired (through the input channels, which include biometric, biological, physiological, behavioral or other personalized digital marker data, etc.) based the type and security requirements of the authentication. The varying of the level, accuracy, and type of input data may be implemented through a feedback process. The on-chip controller 120 (such as the one illustrated in FIG. 1) may be configured to make an authentication decision based on the input from multiple neural engines (e.g., neuromorphic engines).

As noted, the PPU 100 may include on-chip historical data storage 140 to store history data and hardcoded personal data for cross checking, and the on-chip policy engine 150 to determine the security requirements of tasks, and to control (along with the on-chip controller) the data acquisition, selection and authentication decisions.

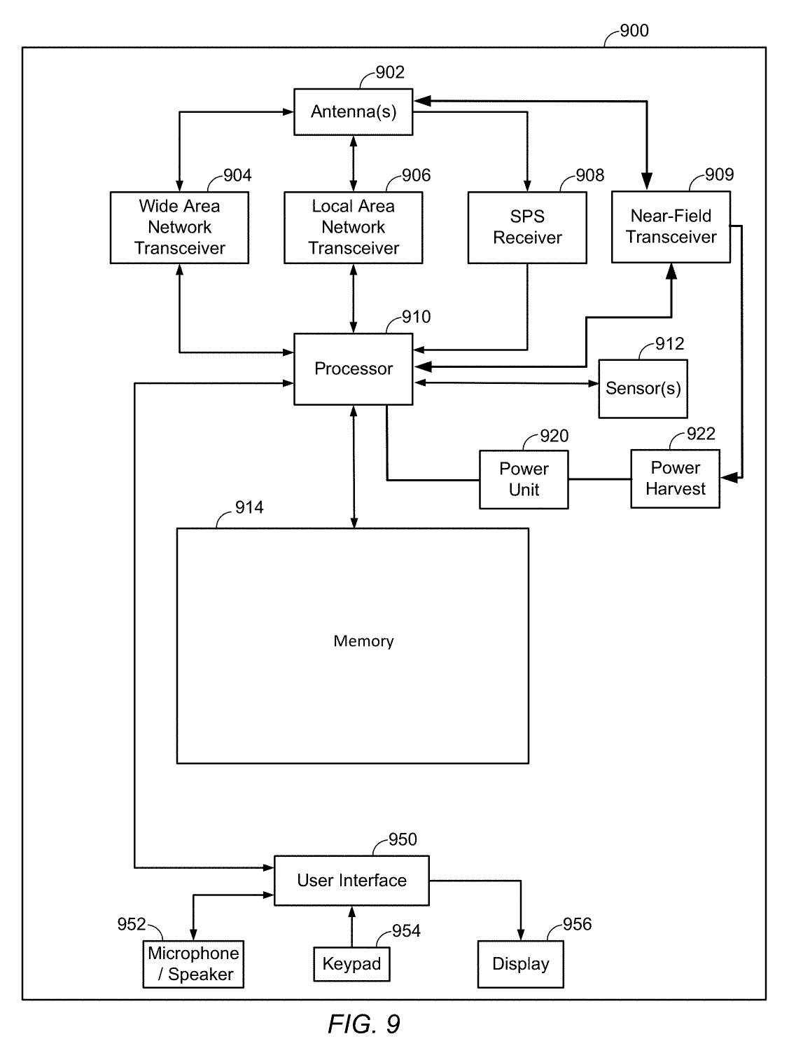

Accordingly, in some embodiments, a personalized processing unit is provided that includes a communication module (as more particularly depicted in FIG. 9) configured to receive user-related data (e.g., biometric data, physiological data, behavioral data, location data, personal data, etc.) from a plurality of input sources, a learning authentication engine configured to authenticate an authorized user based on multiple inputs and correlations between at least some of the multiple inputs, and a processor-based controller, communicatively coupled to the communication module and to the learning authentication engine. The controller is configured derive multiple time-dependent authentication metrics based on the user-related data from the plurality of input sources, apply at least one of the derived multiple time-dependent authentication metrics to the learning authentication engine (e.g., the engine 130 or one or more of the units 110a-n), and generate an authentication signal in response to a determination, by the learning authentication engine, that the derived multiple time dependent authentication metrics correspond to the authorized user. In some embodiments, the controller may further be configured to periodically re-derive the multiple time-dependent authentication metrics based on incoming time-varying user-related data from at least some of the plurality of input sources, and periodically generate subsequent authentication signals in response to determining the periodically re-derived multiple time-dependent authentication metrics correspond to the authorized user.

The user-related data may include one or more of, for example, face image data for a person, eye features data for the person, movement pattern data for the person, keystroke pattern data for the person, signature data for the person, voice data for the person, speech data for the person, geometry data, heart signal data, body temperature data, skin resistance data, pH level data, and/or blood sugar data. The learning authentication engine may include one or more of, for example, a neuromorphic-based learning engine trained using respective user-related data from the multiple inputs for the authorized user, and/or a resistive random-access memory (RRAM)-based learning engine. The learning authentication engine may also be configured to implement fuzzy matching processing. In some embodiments, the communication module may be configured to communicate the authentication signal to one or more remote systems, with the authentication signal being configured to activate or actuate the one or more remote systems such that without the authentication signal, activity of the one or more remote systems is inhibited. The personalized processing unit may further include one or more biometric sensors configured to measure at least some of the user-related data corresponding to one or more of the plurality of input sources.

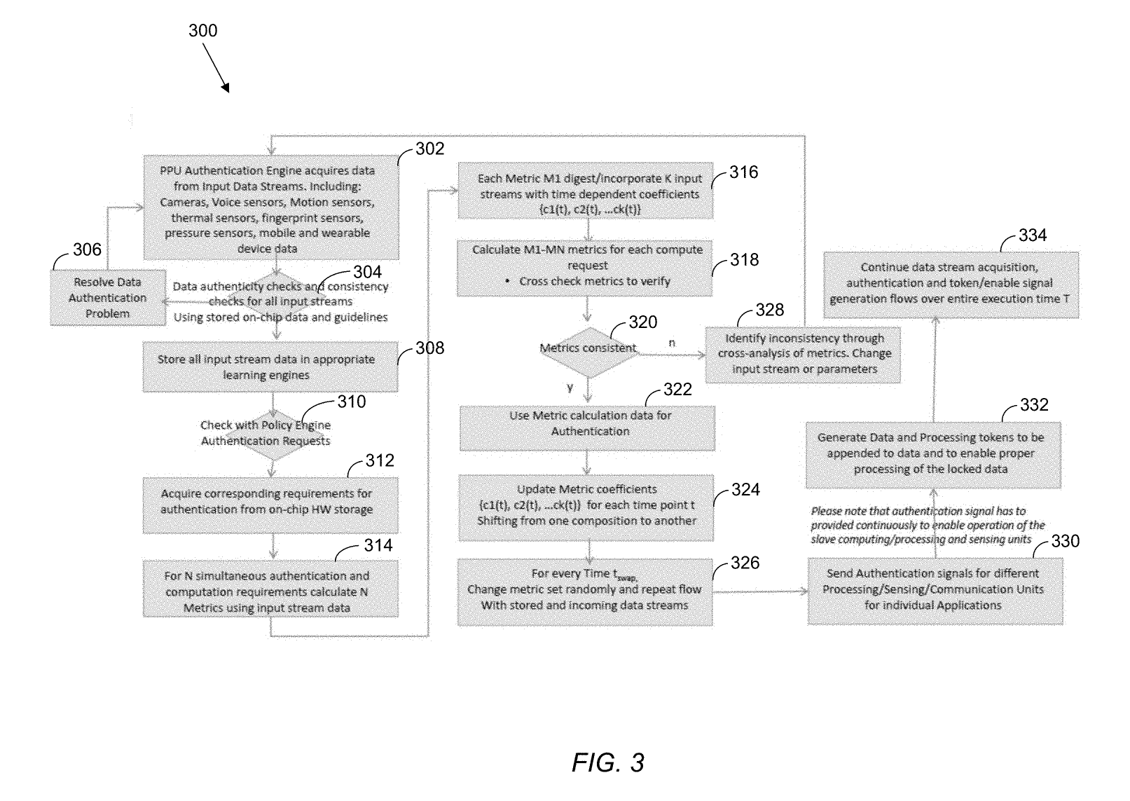

Further details of the operations of a device, such as the PPU 100 of FIG. 1, to implement authentication and secure processing are provided in the flow diagram of FIG. 3 illustrating an example procedure 300. At block 302 where a PPU authentication engine (i.e., a PPU device implemented on a personal user device, such as a smartphone, or on a dedicated processor-based device with one or more sensors) acquires data from input data streams. Such input may be acquired in response to an authentication request sent by a remote device or application. Such input data streams may include one or more light-capture devices (e.g., one or more cameras), voice sensors (e.g., microphones), motion sensors (a gyroscope, an accelerometer), thermal sensors, fingerprint sensors, pressure sensors, biometric sensors (heart monitor, pH monitor, blood-sugar monitor, blood pressure monitor/sensor, or any other type of biometric sensor), mobile and wearable device data, etc. The various sensors can measure, sense, or otherwise acquire data that may be representative of biometric characteristics of a user (e.g., the facial features of the user, the voice of the user, walking pattern (gait) of the user, etc.) The procedure 300 may subsequently, in some embodiments, perform, at 304, data authenticity and consistency checks (e.g., as part of a pre-processing stage) using, for example, on-chip data and guidelines, e.g., determine if the data types correspond to expected types, and otherwise perform pre-processing to determine general validity of the data. If problems are detected, the procedure may perform data authentication problem resolution (at 306) by, for example, discarding data deemed to be corrupted or invalid, and collecting a new set of data points. For example, if it is determined that image data collected may have been blocked by a user's finger (causing darkened image data), the procedure 300 may be directed to re-acquire image data for the user's face.

Data streams that pass the various checks performed at 304, are stored (at 308) at appropriate buffers/memories for processing by the respective learning engines. For example, if the neural network 110a is configured to process facial image data for the user, image data streams obtained from a camera in communication with the PPU (whether from an on-board camera or a remote camera in communication with the PPU), that is determined to correspond to facial features may be stored at the memory 112a associated with the neural network unit 110a.

In some embodiments, the procedure 300 may next check, at 310, authentication requests that may have been received from a remote device (e.g., a remote device requiring authentication confirmation from the PPU before performing an authentication-dependent operation such as granting access to secure data, or performing some other security-sensitive operation). This check may be determined based on policy data maintained at, for example, the policy engine 150, which may specify, for different types of authentication requests (received from different types of remote devices and/or for different authentication-dependent operations) what input sensory data needs to be processed by the PPU 100, which learning engines need to be run (e.g., by loading weights and neural networks configurations from storage), what metrics are to be derived (e.g., by the learning engines selected for execution), what output signals need to be generated by the PPU, etc. Upon determination of the particular processing, and the particular input and output required for an authentication request, the corresponding requirement for the authentication processing are acquired at 312 (e.g., from the on-chip hardware storage).

With the proper data and system configuration set to process a particular authentication request, the procedure 300 computes, at 314 and 316, j metrics (M₁, . . . , Mⱼ) using selected N input data streams (which may include a combination of measured inputs data from various sources). In some embodiments, each metric may incorporate (be based on) k input streams that are processed/filtered with time dependent coefficient. That is, each of the metrics M₁, . . . , Mⱼ may be derived as a combination of time dependent functions applied to the various selected data streams used for a particular authentication request. Thus, for example, a metric M₁ may be computed as a sum of (c_{1,1}(t)*Input₁+c_{2,1}(t)*Input₂+ . . . +c_{N,1}(t)*Input_{N}), while the metric Mⱼ may be computed as a sum according to (c_{1,j}(t)*Input₁+c_{2,j}(t)*Input₂+ . . . +c_{N,j}(t)*Input_{N}). While the present example refers to a sum of time-dependent function, other relationships that define a particular metric (e.g., products, quotients, etc.) may be used to derive anyone of the various metrics. In some embodiments, the metrics may be generated using one or more of the units 110a-n.

Having computed the metric corresponding to a particular authentication request, the values generated for a metric(s), at a particular time instant (the coefficients and definition of the metric may vary as a function of time so as to increase security against hacking attacks), may be cross-checked for consistency, at 318. For example, the metrics that need to be derived for a particular request may have some deterministic relationship between each other that can be examined to detect anomalous data points or anomalous generated metrics. In the event that an inconsistency, anomaly, or some other problem is detected through the cross-check performed at blocks 318 and 320 of the procedure 300, the present authentication processing may be aborted (at block 328) and a new authentication processing may commence at 302.

If the check of the metrics results in a determination that there is no detected problem, inconsistency, or anomaly, further metric measurements may be obtained for different time instances at which input data (from different sources) is collected. For example, at different time instances (t₁, t₂, . . . , tᵢ) within some time window interval, different coefficients, defining the metrics, may be used, thus resulting in different metric functions (e.g., different linear sums) at different time instances (as illustrated in block 324). The particular coefficient values used at different time instances may be based on some deterministic relationship that can be used at the PPU 100 and/or at remote device (in order to confirm the correctness of authentications values generated at the PPU). In some embodiments, for different time windows (that may each include multiple time instances), the data streams used for computing/deriving metrics may be varied/swapped. Thus, for example, at block 326, at time intervals t_{swap}, the metric set may be randomly (or pseudorandomly) changed, and the procedure 300 is repeated with a new set of incoming data streams.

As further illustrated in FIG. 3, at block 330 the procedure 300 sends (periodically or continually) authentication signals (e.g., authentications signals generated based on computed metrics) for different processing, sensing, and communication units for different applications. The authentication signals may be a composite of various metrics (which may be computed, as discussed herein, based on time-dependent functions) and/or resultant values generated by learning engine (such as the engine 130 or any of the units 110a-n). For example, one or more learning engines may have been trained to generate a confirmatory authentication signal in response to a stream of time-dependent metrics generated from time-dependent input signals. The authentication signal may also be a simple indication of whether the user has been authenticated for a particular request (at a particular time) sent by a particular remote device and/or application. The authentication signal may, in some implementations, have to be provided to the requesting device or application continuously.

As noted, in some embodiments, the PPU may be configured to generate authentication token that are included (appended) with data records. Thus, in such embodiments, the procedure 300 may be configured to generate, at block 332 (when needed), authentication signals to allow a requesting remote device or application to access a data record comprising such an authentication token. Because the authentication signals may be based on biometric data (which may not be identical to the data used to generate an original authentication token), a determination as to whether an authentication signal sent corresponds or matches an authentication token added to a data record may be allow for some deviation between the authentication signal and the original token (i.e., a match may be determined to occur when there is sufficient closeness or similarity between a later authentication signal and an earlier authentication token).

As further indicated in FIG. 3, data stream acquisition may continue (to generate authentication signals responsive to authentication requests) over the execution time T (at block 334).

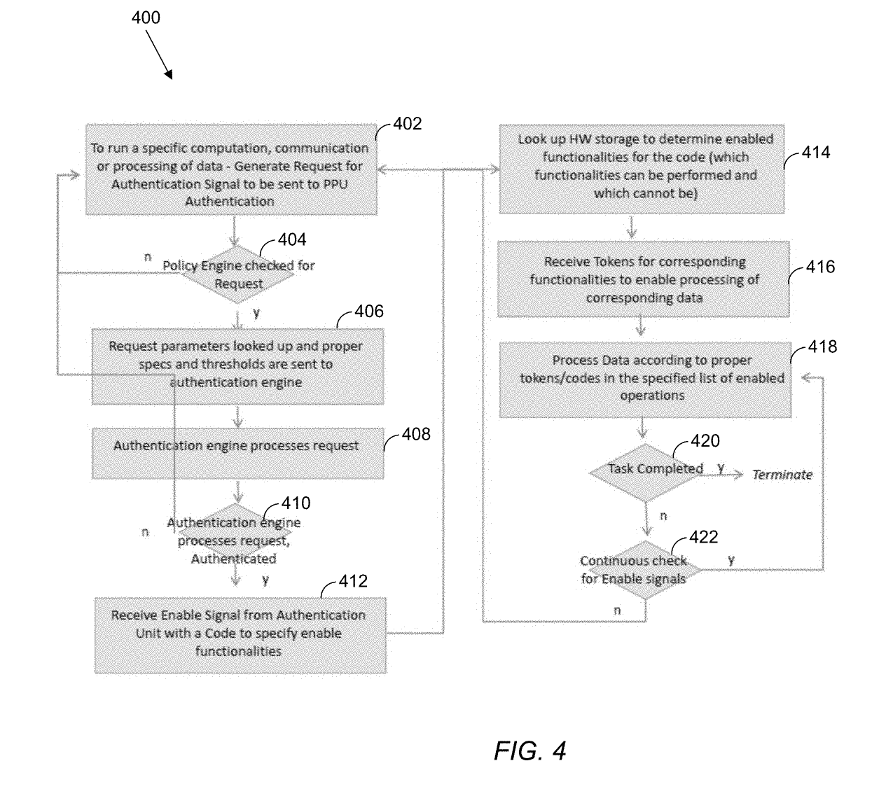

With reference next to FIG. 4, a flow diagram of an example procedure 400, generally executed at a remote requesting device and communicated to PPU device, to make authentication requests and receive response thereto, is shown. Thus, a remote device that requires an authentication signal in order to run a specific computation, process an access-restricted data record, or handle a communication, generates and transmits to a PPU device (such as the PPU illustrated in FIG. 1), via a wired communication link or a wireless communication link, a request for an authentication signal (at block 402 of FIG. 4). The authentication request may identify a particular user for which authentication is required (e.g., to determine, based for example on biometric data receivable at the PPU, whether a person at the PPU corresponds to the particular identified user). Alternatively, the authentication request may simply ask for authentication signals that will be used, at the requesting device, to make a determination of whether the authentication signals correspond to some particular user.

In response to the request, a policy engine (typically located at the PPU, such as the policy engine 150 of the PPU 100) is accessed and checked, at block 404. If no policy records can be found for the authentication request (e.g., because it is for a faulty request, because no user or entity policy records corresponding to the request can be identified, or for some other reason), the request may be aborted (the procedure 400 would then commence again when a new authentication request is needed).

If a corresponding policy record can be located by the policy engine, request parameters can be looked up to identify information needed to serve the authentication request. For example, particular learning engines (e.g., to be run on the neural networks 110a-n) are determined and configured, threshold and other parameters to process input and intermediate data are loaded, and the authentication metrics (and functions to derive such metrics) are provided to the proper modules of the PPU (at block 406). The authentication engine (implemented on the PPU) can then process the authentication request at block 408 (e.g., according to the procedure 300 discussed in relation to FIG. 3). At block 410, a determination is made as to whether the authentication engine successfully processed the authentication request and generated an authentication signal. If the authentication engine did not successfully complete the request, the current processing of the authentication request is aborted (the procedure 400 would start again when a new authentication request is generated at some later point). If the authentication request was successfully completed, the requesting device or application receives, at block 412, an authentication signal or code. The received authentication signal/code may represent allowed functionalities that the received device/application is authorized to perform (e.g., access a data record, complete a transaction, etc.)

The received authentication signal or code can be used, in some embodiments, to look-up hardware storage (of the remote device/application that originally generated the authentication request) to determine the functionalities and permissions associated with the received authentication signal (at block 414). In some examples, and as shown at block 416, the authentication signals may include authentication tokens that can be used to control access to particular data record (that may have originally been embedded with authentication tokens). A remote device or application can thus process data according to proper token/codes in the specified list of allowed operations (at block 418). Upon a determination, at block 420, that the task for which the authentication request was made has been completed, the procedure 400 may be terminated. If the task has not yet been completed, the procedure 400 continues to check for authentication signals (responsive to the original authentication request or to continued on-going follow-up authentication requests) at block 422.

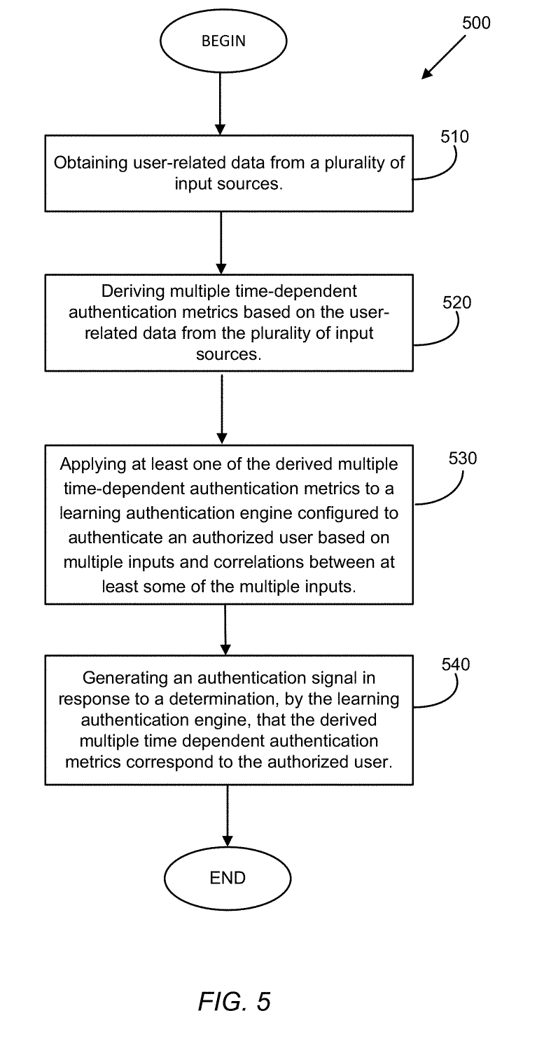

With reference next to FIG. 5, a flowchart of an example procedure 500, generally performed at a PPU, to perform authentication operations is shown. The procedure 500 may be part of, or may incorporate, at least some of the operations described in relation to FIGS. 3 and 4. The procedure 500 includes obtaining 510 user-related data from a plurality of input sources. In some embodiments, obtaining the user-related data may include obtaining the user-related data via one or more of, for example a wearable device, a mobile device, and/or a remote wireless device. The user-related data may include one or more of, for example, user-related biometric data, user-related physiological data, user-related behavioral data, and/or user-related location data. In some embodiments, obtaining the user-related data may include obtaining one or more, for example, face image data for a person, eye features data for the person, movement pattern data for the person, keystroke pattern data for the person, signature data for the person, voice data for the person, speech data for the person, geometry data, heart signal data, body temperature data, skin resistance data, pH level data, and/or blood sugar data.

With continued reference to FIG. 5, the procedure 500 may further include deriving 520 multiple time-dependent authentication metrics based on the user-related data from the plurality of input sources, and applying 530 at least one of the derived multiple time-dependent authentication metrics to a learning authentication engine configured to authenticate an authorized user based on multiple inputs and correlations between at least some of the multiple inputs. As noted, in some embodiments, the learning authentication engine may include a neuromorphic-based learning engine trained using respective user-related data from the multiple inputs from the authorized user. In some examples, the learning authentication engine may be configured to implement fuzzy matching processing. In some implementations, the learning authentication engine may include multiple neural network units (such as the units 110a-n of FIG. 1) to receive respective ones of multiple authentication data streams (either as raw input data or generated metrics data), with at least one of the respective ones of the multiple authentication data streams including the at least one of the derived multiple time-dependent authentication metrics. In such embodiments, the method may further include periodically varying inputs of the multiple neural network units to switch the respective ones of the multiple authentication data streams being directed to the inputs of the multiple neural network units.

The procedure 500 also includes generating 540 an authentication signal in response to a determination, by the learning authentication engine, that the derived multiple time dependent authentication metrics (and/or raw input data) correspond to the authorized user. The signal may be a one-time generated value, or a sequence of values sent of a time interval. The authentication signal may be configured to activate one or more remote systems such that without the authentication signal, activity of the one or more remote systems is inhibited. Such one or more remote systems may include, for example, a mobile phone, a remote financial server, and/or a medical server storing medical information.

In some embodiments, the method may further include periodically re-deriving the multiple time-dependent authentication metrics based on incoming time-varying user-related data from at least some of the plurality of input sources, and periodically generating subsequent authentication signals in response to determining the periodically re-derived multiple time-dependent authentication metrics correspond to the authorized user. In some embodiments, the method may further include generating data tokens in response to the determination, by the learning authentication engine, that the derived multiple time dependent authentication metrics correspond to the authorized user, and including the data tokens with data records associated with the authorized user so as to mark the data records and inhibit unauthorized use of the data records associated with the authorized user.

Another example procedure that may be implemented on a PPU includes obtaining user-related data from a plurality of input sources, deriving multiple time-dependent authentication metrics based on the user-related data from the plurality of input sources, applying at least one of the derived multiple time-dependent authentication metrics to a learning authentication engine configured to authenticate an authorized user based on multiple inputs and correlations between at least some of the multiple inputs, and performing an authentication task in response to a determination, by the learning authentication engine, that the derived multiple time dependent authentication metrics correspond to the authorized user. Performing the authentication task includes one or more of, for example, generating an authentication signal to activate one or more remote systems such that without the authentication signal, activity of the one or more remote systems is inhibited, and/or generating data tokens for embedding in data records associated with the authorized user so as to mark the data records and inhibit unauthorized use of the data records associated with the authorized user. In some embodiments, a personal processing unit (PPU) implementing such a method may correspond to a master device driving the computation of slave computing engines (such as cell phones, personal computing devices, wearable and medical devices, etc.) The data processing capabilities of the slave computing engines can thus be disabled/limited without the authentication signals generated by the PPU.

### Autonomous Systems

Also described herein are systems, devices, apparatus, methods, computer program products, media, and other implementations, to process video and audio intensive tasks (and tasks for other data types) through neuromorphic architectures (which may be similar, in some embodiments, the neural networks 110a-n employed in the implementations of the PPU 100 of FIG. 1). The proposed approach uses neuromorphic computing systems to: (i) efficiently compute highly unstructured/unreliable/real-time streaming data in the forms of video, audio/acoustic sensor data, light/radio sensor data, etc., (ii) implement on-board hardware for communication across devices, as well as data storage, and (iii) perform continuous learning and autonomous decision-making abilities in the embedded systems themselves.

The implementations described herein include an on-chip controller (a global controller) that resides on a first layer of the computing/storage/communication stack that is responsible for distributing the data to various computing columns dynamically in an optimized fashion (the on-chip global controller may be realized similarly to the authentication controller 120 of FIG. 1). For instance, depending on the resolution of the data, more than one image processing column may be activated to process the incoming data. The on-chip controller is further configured to interpret the fuzzy outcomes from individual engines, and to merge and arbitrate the outcomes from the similar functioning engines to consolidate the results. Additionally, the implementations described herein are configured to use results from engines with non-overlapping functionality (such as acoustic and image processing engines), and to consolidate results from the risk and security threat engines that run in parallel with the regular computing engines. In some embodiments, the controller is further configured to perform decision making (using deep learning capabilities) on the risk and security outcomes of various actionable scenarios based on the engine data. The implementations described herein also implement internal system training, including training the internal deep learning (neural-network based) engines based on the outcomes/feedback at run-time, non-volatile memory storage of the relevant data, and the merged decisions from the multiple deep learning systems based, for example, on customized weights [wᵢ-w_{N}].

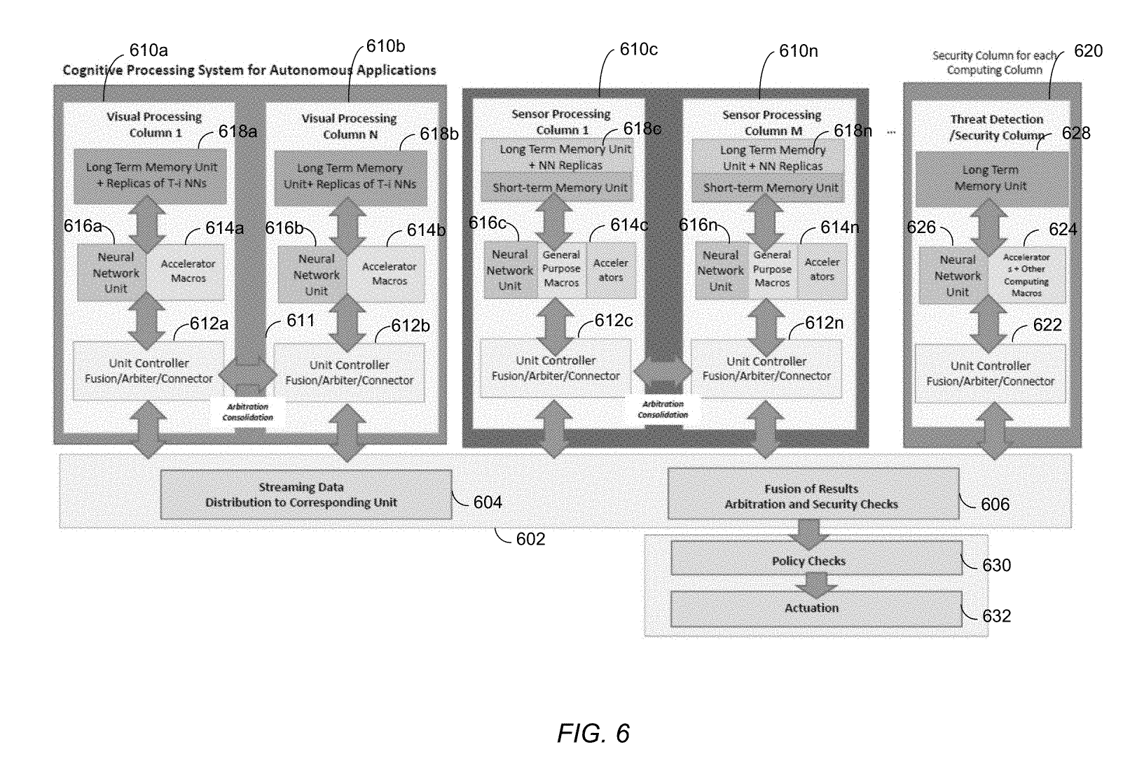

With reference to FIG. 6, a block diagram of a cognitive processing system 600 to implement an autonomous application is shown. As illustrated, the system includes a plurality of processing columns 610a-n that are each configured to receive real-time data (corresponding to one of a plurality of data types) from multiple input sources (such as audio sensors, video sensors, orientation/inertial sensors, biometric sensors, etc.). Each processing column may include a respective unit controller 612a-n (e.g., a dedicated processor-based controller, or a controller thread assigned from the hardware resources of a global controller 602) to control fusion, arbitration, and connector functionalities of the processing columns. Each processing column may also include general purpose and accelerator macros, neural network units for that processing column, and a non-volatile memory unit (e.g., to store replicas of data directed to that column, and one or more sets of configuration data to configure the neural network or some other type of realized learning engine or classifier). The system may also include a threat detection/security column 620. Similarly to the learning engines of the PPU 100, in some embodiments, various learning engines may be used to implement the classification processes of the autonomous system 600 (e.g., classification processes to generate possible actionable outcomes and their associated risks, to, for example, make a navigation/driving decision based on the generated output). Examples of learning engines include neural network-based engines, support vector machines (e.g., one implementing a non-linear radial basis function (RBF) kernel), engines based on implementations of a k-nearest neighbor procedure, engines implementing tensor density procedures, engines implementing hidden Markov model procedures, etc. Examples of neural networks that can be used to implement the learning engines of the system 600 include convolutional neural network (CNN), recurrent neural networks (RNN), etc. Certain learning engine configurations may be used for specific data types. For example, convolutional layers may be suitable to process image data. In some embodiments, for example when computing resources (memory) provided on a device are scarce, Recursive Binary Neural Network (RBNN) learning systems may be realized.

The global controller 602, coupled to the plurality of processing columns, is configured to direct the received real-time data (from the multiple input sources) to the various processing columns (using a director module 604), and to fuse the outputs from the processing columns to generate a plurality of action options representative of actions performable by the autonomous system (e.g., using a fusion unit 606). Each of the action options may be associated with respective metrics, with those metrics comprising action risk metrics (that may have been computed, at least in part, using the threat detection/security column 620). The global controller is further configured to select one of the action options based, at least in part, on the respective metrics associated with the plurality of action options. The selection of the action may further be based on policy checks (controlled by a policy checks controller 630) applied to the actions (e.g., to ensure consistency between the possible action and any restrictions in relation to the actions). A selected action is executed by, for example, an actuation module 632 configured to generate control signals to actuate the system being controlled by the system 600 (e.g., to cause a steering unit of a vehicle to steer in a selected direction, slow down the vehicle, etc.)

In some embodiments, to prevent adversarial training, the system may maintain N replicas of the neural networks, each with different training input combinations and/or different training frequencies, and with some of the neural networks used as pure replicas for system failures. The system 600 is thus configured for: a) reversion of adversarial training triggered by threat exposure and risk metric calculations, b) random selection of input data and decision recommendations, and continuous recalculation of recommended action, and b) long term and short-term reference data, stored in neural network storage for history-based decision making, where short term data is rewritten based on threat and risk metrics. The system 600 is also configured for continuous energy optimization through selection of input channels (data resolution and other variable parameters), and performance of selected action for the given decisions and environment conditions.

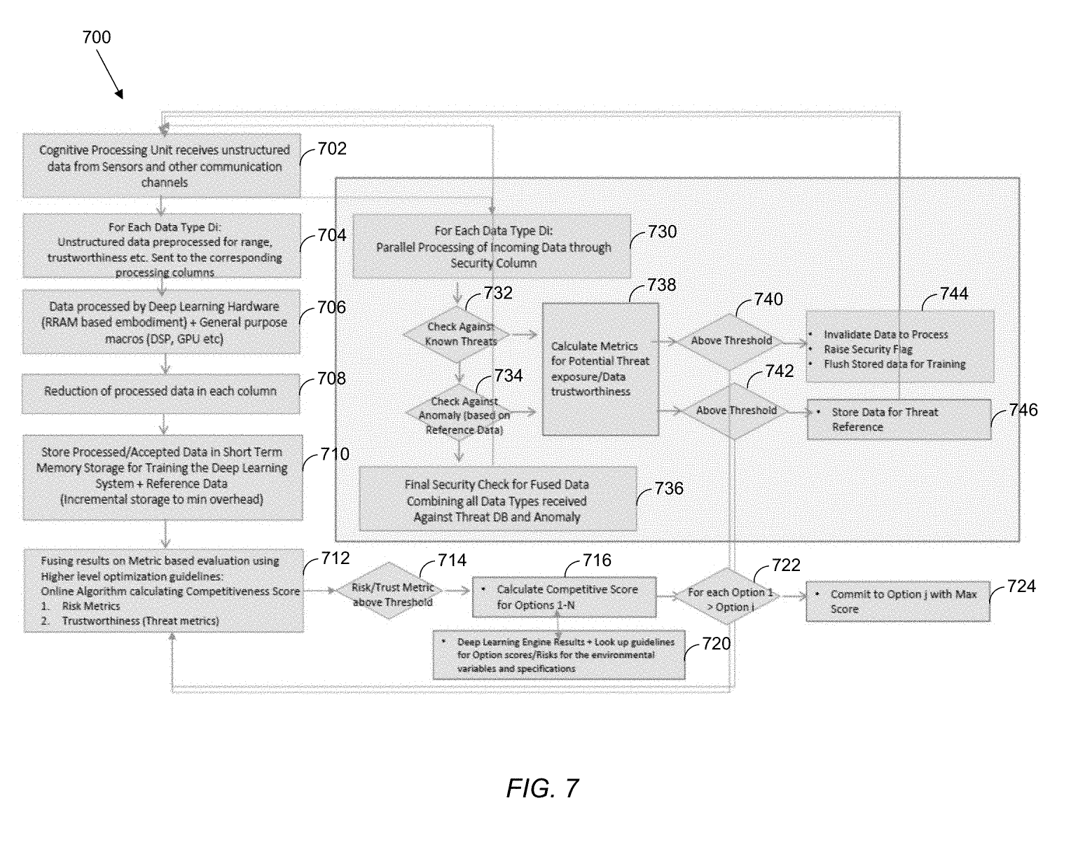

Operations performed by the system 600 are described in relation to FIG. 7, which provides a flow diagram of an example procedure 700 implemented by the system 600 to control an autonomous system (such as a navigation system for a self-driving car). As shown, a cognitive processing system, such as the system 600, receives at block 702, for example via the controller 602, unstructured data from sensors and other communication channels. The sensors providing at least some of the data streams may be local sensors that collect real-time data (e.g., motion data, location data, image and audio data and so), or alternatively may be remote sensor devices, deployed over a large area, configured to communicate the data streams to the system 600 via wired or wireless communication channels. For each data type D corresponding to a received data stream, the unstructured data is preprocessed, at block 704 (which may be performed by the unit 604 of the system 600) to determine the range and reliability of the data. Additionally, the preprocessing may also include operations such as pre-processing filtering, decompression, decryption, sampling, and other such operations. The pre-processed data streams can then be directed to appropriate processing columns based on the resultant pre-processed data. For example, an unstructured image data may be directed (after appropriate pre-processing to a column such as column 610a which may be configured to process image data) to a processing column designated to process image data.

Each data stream directed to its appropriate processing column is processed, at block 706, by a deep learning hardware (e.g., the neural network units 616a-n of FIG. 6) configured for the specific data type (image data, motion data, location data, audio data, RF data transmitted from neighboring vehicles, biometric data representative of actions and reactions by a passenger or driver), as well as by general purpose hardware and macros (DSP processor, a GPU, etc., which can be realized as part of the modules 614a-n of FIG. 6) At block 708, the processing of a data set in each column stream results in a reduced data output, which, depending on the particular column and data type, could include a truncated data set, metadata generated for the processed data (e.g., based on the learning engine processing), metrics, signals representative of an output characteristic(s) of the data, etc. The resultant data is then stored, at block 710, in memory storage that can be used for subsequent training of the learning engines, as well for future reference data. The storage of data may be selective and/or incremental to minimize overhead.

As further illustrated in FIG. 7, having generated the resultant processed data by the different processing columns, a data fusion process is performed (at block 712) to fuse data coming from identical (redundant) processing engines or sensors and alternative computational engines or sensors are. It is to be noted that in some embodiments, to mitigate risk of erroneous actions committed by autonomous systems, a particular data stream may be processed by multiple redundant columns, with the respective results from such redundant columns being arbitrated or consolidated (as illustrated, for example, in relation to the columns 610a and 610b, whose respective results are consolidated/arbitrated using an arbitration unit 611). The fusion process combines parallel computational columns based on threat and risk metrics (which may have been produced by the various learning engines, or by some other process operating on resultant data), previously stored and learned solutions available in system storage, competitive processes for adversarial or online decision making, and/or other factors. The data fusion results in generation of action options (e.g., to control a vehicle where the system is implemented for autonomous driving) that are associated with a risk or trust metric. The respective risks/trust metrics are checked, at block 714, to ascertain that they exceed respective threshold (e.g., to ensure that a minimal level safety or trust in the proposed actions is achieved), and if so, competitive scores for each of the surviving possible actions are computed (at block 716, using, at block 720, deep learning engine results, and having regard to guidelines specifying option scores and risks for environmental variables and specification).

In some implementations, and as shown in FIG. 7, while being processed by the processing columns 610a-n, the data streams may be processed (substantially concomitantly) by the security column 620 (at block 730). In some embodiments, a respective security column may be realized for each of the processing column 610a-n. The data stream may thus be checked, at block 732, for known threats, as well as to detect anomalies in the data (at block 734) based on stored reference data. A final security check may be performed, at block 736, for fused data by using a threat and anomaly database.

The checked data (with anomalous data, or potentially contaminated or corrupted data, being discarded) is then processed, at block 738, to compute metrics for potential threat exposure and data trustworthiness, and the computed metrics are compared to pre-determined thresholds (at blocks 740 and/or 742). For metrics satisfying the threshold checks, the metrics and/or the respective underlying data may be provided to the block 720 to facilitate the computation of the competitive scores for the various action options. If a metric fails the threshold test, the underlying data may be invalidated and/or discarded (at block 744). In some embodiments, data processed by the security column 620 may be stored as a threat reference data (at block 746).

Having computed scores for various action options, an action option with a maximum score may be selected (at block 724), and the system 600 may then cause (e.g., through the actuation module 632) the system or device being controlled (e.g., a vehicle) to perform the selected option. In some embodiments, selection of the action option may be based on some other criterion (e.g., the action selected may be the one corresponding to a median score of the scores computed).

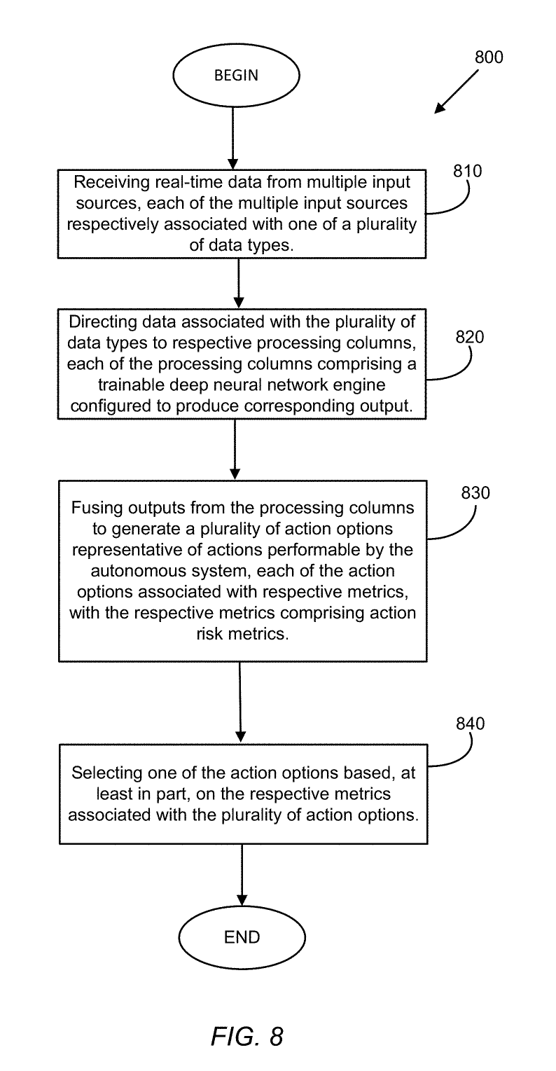

With reference next to FIG. 8, a flowchart of an example procedure 800 for neuromorphic processing for an autonomous system is shown. The procedure includes receiving 810 real-time data from multiple input sources, with each of the multiple input sources respectively associated with one of a plurality of data types. Having received the data from the multiple sources, the procedure further includes directing 820 data associated with the plurality of data types to respective processing columns (e.g., such as the columns 610a-n of FIG. 6) that each comprises a trainable deep neural network engine configured to produce corresponding output.

The procedure 800 further includes fusing 830 outputs from the processing columns to generate a plurality of action options representative of actions performable by the autonomous system, with each of the action options associated with respective metrics, and with the respective metrics comprising action risk metrics. The procedure 800 then selects 840 one of the action options based, at least in part, on the respective metrics associated with the plurality of action options.

In some embodiments, the multiple input sources may include one or more of, for example, a video input source, an audio input source, and/or an RF input source. In some embodiments, the procedure may further include applying at least the selected one of the action options to further train the trainable neural network engine of at least one of the processing columns.

In some embodiments, additional implementations of the system 600 or the operations described in relation to FIGS. 6-8 may include methods to train multiple neural networks (e.g., the neural networks used by processing columns to produce output corresponding to the input data that the processing columns receive) for various settings/environments/historical patterns. In such additional implementations, each network may include a custom training cycle that's potentially different from others. Furthermore, a controller in such additional implementations may be configured to decide/determine subsets of NN (Neural network) engines results to select from, and may also be configured to determine another subset of NN engines to train, and which data to use to train that other subset of NN engines. In some variations, a metric-based decision process may be used for threat profiling, security-based data and decisions, and risk-based actuation.

Example embodiments (which may be used in conjunction with other embodiments described herein) may further include a method for system-wide parallel custom security columns to specifically learn from historical patterns, anomalies, known threat patterns, etc., in parallel with the other learning and decision engines. In such example embodiments, each network/column/engine factors in the security column information to process data, for decision process and training process, as well as for storing data (in short or long-term memory).

In yet additional example embodiments (which may also be used in conjunction with other embodiments described herein), a controller and method are provided to decide which engine/column output to use, and to arbitrate/de-conflict individual engine/column decisions based on, for example, (i) risk profiles of the actuation decisions, (ii) quality and characteristics of incoming data, and (iii) security and threat profiles (etc.) In such additional example embodiments, data storage and training decisions may be based on threat and security analysis (in some cases the data associated with highly risky inputs may not be stored or used to train the engines; such data may be excluded/disregarded from storage).

In additional example variations, systems (such as those described herein) are provided that comprise arbitration engines, learning engines (Neural Networks), general or accelerator macros, non-volatile memory units (for short/long term memory) that are placed in vertical column alignment, where interconnectivity between vertical layers and cross bar in the end-layers create functional connectivity for column processing. In such additional example variations, activities can be dynamically configured to populate one or more columns based on the underlying processing requirements. Also in such additional example variations, individual functional layers may be made of disparate manufacturing technologies and may be integrated through 3D integration (such as computing, storage, interconnectivity, etc.)

### Additional Example Embodiments and Implementations

FIG. 9 is a schematic diagram of an example device 900, which may be similar to, and be configured to have a functionality similar to that of, the PPU 100 of FIG. 1, the system 600 of FIG. 6, or any other device or system in communication with a device such as the PPU 100 or the system 600, or that is otherwise used in conjunction with the systems 100 or 600, or any of the implementations discussed herein with respect to FIGS. 1-8. Additionally, the example device 900 may be used to implement, in whole or in part, any of the various modules discussed in relation to the systems 100 or 600 (e.g., to implement any of the neural network units or other learning engines used in conjunction with the systems 100 or 600 of FIGS. 1 and 6). It is to be noted that one or more of the modules and/or functions illustrated in the example of FIG. 9 may be further subdivided, or two or more of the modules or functions illustrated in FIG. 9 may be combined. Additionally, one or more of the modules or functions illustrated in FIG. 9 may be excluded.

As shown, the example device 900 may include one or more transceivers (e.g., a LAN transceiver 906, a WLAN transceiver 904, a near-field transceiver 909, etc.) that may be connected to one or more antennas 902. The transceivers 904, and 906, and/or 909 may comprise suitable devices, hardware, and/or software for communicating with and/or detecting signals to/from a network or remote devices (such as devices provided data streams that are processed by the learning engines implemented for the systems 100 or 600) and/or directly with other wireless devices within a network. In some embodiments, by way of example only, the transceiver 906 may support wireless LAN communication (e.g., WLAN, such as WiFi-based communications) to thus cause the device 900 to be part of a WLAN implemented as an IEEE 802.11x network. In some embodiments, the transceiver 904 may support the device 900 to communicate with one or more cellular access points, which may be used for wireless voice and/or data communication. A wireless wide area network (WWAN) may be part of a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMax (IEEE 802.16), and so on. As noted, a CDMA network may implement one or more radio access technologies (RATs) such as cdma2000, Wideband-CDMA (W-CDMA), and so on. Cdma2000 includes IS-95, IS-2000, and/or IS-856 standards, and a TDMA network may implement Global System for Mobile Communications (GSM), Digital Advanced Mobile Phone System (D-AMPS), or some other RAT.

As described herein, in some variations, the device 900 may also include a near-field transceiver (interface) configured to allow the device 900 to communicate according to one or more near-field communication protocols, such as, for example, Ultra Wide Band, ZigBee, wireless USB, Bluetooth® (classical Bluetooth), Bluetooth-Low-Energy® (BLE) protocol, etc. When the device on which a near-field interface is included is configured to only receive near-field transmissions, the transceiver 909 may be a receiver and may be not capable of transmitting near-field communications.

As further illustrated in FIG. 9, in some embodiments, an SPS receiver 908 may also be included in the device 900. The SPS receiver 908 may be connected to the one or more antennas 902 for receiving satellite signals. The SPS receiver 908 may comprise any suitable hardware and/or software for receiving and processing SPS signals. The SPS receiver 908 may request information as appropriate from the other systems, and may perform the computations necessary to determine the device's 900 position using, in part, measurements obtained by any suitable SPS procedure. Such positioning information may be used, for example, to determine the location and motion of the device 900. Additionally and/or alternatively, the device 900 may derive positioning information based on signals communicated to and from access points (and/or base stations), e.g., by performing multilateration position determination procedures based on metrics derived from the communicated signals. Such metrics from which the device 900's position may be determined include, for example, timing measurements, signal-strength measurements, etc.

In some embodiments, one or more sensors 912 may be coupled to a processor 910 to provide data that includes relative movement and/or orientation information, biometric data information, image and audio data, and other types of data. By way of example but not limitation, sensors 912 may utilize an accelerometer (e.g., a MEMS device), a gyroscope, a geomagnetic sensor (e.g., a compass), and/or any other type of motion/orientation sensors. Moreover, sensor 912 may include a plurality of different types of devices and combine their outputs in order to provide motion information. The one or more sensors 912 may further include an altimeter (e.g., a barometric pressure altimeter), a thermometer (e.g., a thermistor), an audio sensor (e.g., a microphone), a camera or some other type of optical sensors (e.g., a charge-couple device (CCD)-type camera, a CMOS-based image sensor, etc., which may produce still or moving images that may be displayed on a user interface device, and that may be further used to determine an ambient level of illumination and/or information related to colors and existence and levels of UV and/or infra-red illumination). The sensors 912 may also include biometric sensors (such as heart monitor, pH monitor, blood-sugar monitor, blood pressure sensor, and so on), and/or other types of sensors. The output of the one or more sensors 912 may provide data that may be used to perform authentication and navigation operations (e.g., to provide authentication signals, actuation signals, etc.) in relation to the systems and other implementations described herein.

With continued reference to FIG. 9, the device 900 may include a power unit 920 such as a battery and/or a power conversion module that receives and regulates power from an outside source. In some embodiments, when the device 900 may not have readily available access to replacement power (e.g., replacement batteries) or AC power, the power source 920 may be connected to a power harvest unit 922. The power harvest unit 922 may be configured to receive RF communications, and harvest the energy of the received electromagnetic transmissions (although FIG. 9 illustrates the unit 922 receiving RF communication via the near-field interface 909, the power harvest unit 922 may be connected to, and receive RF energy from, any of the other communication interfaces depicted in FIG. 9). An RF harvest unit generally includes an RF transducer circuit to receive RF transmissions, coupled to an RF-to-DC conversion circuit (e.g., an RF-to-DC rectifier). Resultant DC current may be further conditioned (e.g., through further filtering and/or down-conversion operation to a lower voltage level), and provided to a storage device realized, for example, on the power unit 920 (e.g., capacitor(s), a battery, etc.)

The processor (also referred to as a controller) 910 may be connected to the transceivers 904, 906, and/or 909, the SPS receiver 908 and the sensors 912. The processor may include one or more microprocessors, microcontrollers, and/or digital signal processors that provide processing functions, as well as other calculation and control functionality. The processor 910 may also include memory 914 for storing data and software instructions for executing programmed functionality within the device. In some embodiments, special purpose logic circuitry, e.g., an FPGA (field programmable gate array), an ASIC (application-specific integrated circuit), a DSP processor, a GPU, etc., may be used to implement the controller 910.

The functionality implemented via software may depend on the particular device at which the memory 914 is housed, and the particular configuration of the device and/or the devices with which it is to communicate. For example, the memory 914 may include software-based applications to facilitate implementation of a PPU (such as the PPU 100 of FIG. 1), a cognitive processing system for an autonomous application (such as the system 600 of FIG. 6), or any other type of system configuration. The memory 914 may be on-board the processor 910 (e.g., within the same IC package), and/or the memory may be external memory to the processor and functionally coupled over a data bus.

The example device 900 may further include a user interface 950 which provides any suitable interface systems, such as a microphone/speaker 952, a keypad 954, and a display 956 that allows user interaction with the mobile device 900. A user interface, be it an audiovisual interface (e.g., a display and speakers) of a smartphone, a tablet-based device, or some other type of interface (visual-only, audio-only, tactile, etc.), are configured to provide status data, alert data, and so on, to a user using the particular device 900. The microphone/speaker 952 provides for voice communication functionality (and may also be a source of input biometric data), the keypad 954 includes suitable buttons for user input (which may also serve to provide input biometric data), the display 956 includes any suitable display, such as, for example, a backlit LCD display, and may further include a touch screen display for additional user input modes. The microphone/speaker 952 may also include or be coupled to a speech synthesizer (e.g., a text-to-speech module) that can convert text data to audio speech so that the user can receive audio notifications. Such a speech synthesizer may be a separate module, or may be integrally coupled to the microphone/speaker 952 or to the controller 910 of the device of FIG. 9.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

Although particular embodiments have been disclosed herein in detail, this has been done by way of example for purposes of illustration only, and is not intended to be limit the scope of the invention, which is defined by the scope of the appended claims. Features of the disclosed embodiments can be combined, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

What is claimed is:

1. A method comprising:
obtaining user-related data from a plurality of input sources;
deriving multiple time-dependent authentication metrics based on the user-related data from the plurality of input sources;
applying at least one of the derived multiple time-dependent authentication metrics to a learning authentication engine configured to authenticate an authorized user based on multiple inputs and correlations between at least some of the multiple inputs; and
generating an authentication signal in response to a determination, by the learning authentication engine, that the derived multiple time dependent authentication metrics correspond to the authorized user.

2. The method of claim 1, further comprising:
periodically re-deriving the multiple time-dependent authentication metrics based on incoming time-varying user-related data from at least some of the plurality of input sources; and
periodically generating subsequent authentication signals in response to determining the periodically re-derived multiple time-dependent authentication metrics correspond to the authorized user.

3. The method of claim 1, wherein obtaining the user-related data comprises obtaining the user-related data via one or more of: a wearable device, a mobile device, or a remote wireless device;
and wherein the user-related data comprises one or more of: user-related biometric data, user-related physiological data, user-related behavioral data, or user-related location data.

4. The method of claim 1, wherein obtaining the user-related data comprises obtaining one or more: face image data for a person, eye features data for the person, movement pattern data for the person, keystroke pattern data for the person, signature data for the person, voice data for the person, speech data for the person, geometry data, heart signal data, body temperature data, skin resistance data, pH level data, or blood sugar data.

5. The method of claim 1, wherein the learning authentication engine comprises a neuromorphic-based learning engine trained using respective user-related data from the multiple inputs from the authorized user.

6. The method of claim 1, wherein the learning authentication engine is configured to implement fuzzy matching processing.

7. The method of claim 1, wherein the authentication signal is configured to activate one or more remote systems such that without the authentication signal, activity of the one or more remote systems is inhibited.

8. The method of claim 7, wherein the one or more remote systems include: a mobile phone, a remote financial server, or a medical server storing medical information.

9. The method of claim 1, further comprising:
generating data tokens in response to the determination, by the learning authentication engine, that the derived multiple time dependent authentication metrics correspond to the authorized user; and
including the data tokens with data records associated with the authorized user so as to mark the data records and inhibit unauthorized use of the data records associated with the authorized user.

10. The method of claim 1, wherein the learning authentication engine comprises multiple neural network units to receive respective ones of multiple authentication data streams, wherein at least one of the respective ones of the multiple authentication data streams comprises the at least one of the derived multiple time-dependent authentication metrics, and wherein the method further comprises:
periodically varying inputs of the multiple neural network units to switch the respective ones of the multiple authentication data streams being directed to the inputs of the multiple neural network units.

11. A personalized processing unit comprising:
a communication module configured to receive user-related data from a plurality of input sources;
a learning authentication engine configured to authenticate an authorized user based on multiple inputs and correlations between at least some of the multiple inputs; and
a processor-based controller, communicatively coupled to the communication module and to the learning authentication engine, and configured to:
derive multiple time-dependent authentication metrics based on the user-related data from the plurality of input sources;
apply at least one of the derived multiple time-dependent authentication metrics to the learning authentication engine; and
generate an authentication signal in response to a determination, by the learning authentication engine, that the derived multiple time dependent authentication metrics correspond to the authorized user.

12. The personalized processing unit of claim 11, wherein the controller is further configured to:
periodically re-derive the multiple time-dependent authentication metrics based on incoming time-varying user-related data from at least some of the plurality of input sources; and
periodically generate subsequent authentication signals in response to determining the periodically re-derived multiple time-dependent authentication metrics correspond to the authorized user.

13. The personalized processing unit of claim 11, wherein the user-related data comprises one or more: face image data for a person, eye features data for the person, movement pattern data for the person, keystroke pattern data for the person, signature data for the person, voice data for the person, speech data for the person, geometry data, heart signal data, body temperature data, skin resistance data, pH level data, or blood sugar data.

14. The personalized processing unit of claim 11, wherein the learning authentication engine comprises multiple neural network units to receive respective ones of multiple authentication data streams, wherein at least one of the respective ones of the multiple authentication data streams comprises the at least one of the derived multiple time-dependent authentication metrics;
and wherein the controller is further configured to:
periodically vary inputs of the multiple neural network units to switch the respective ones of the multiple authentication data streams being directed to the inputs of the multiple neural network units.

15. A method for neuromorphic processing for an autonomous system, the method comprising:
receiving real-time data from multiple input sources, each of the multiple input sources respectively associated with one of a plurality of data types;
directing data associated with the plurality of data types to respective processing columns, each of the processing columns comprising a trainable deep neural network engine configured to produce corresponding output;
fusing outputs from the processing columns to generate a plurality of action options representative of actions performable by the autonomous system, each of the action options associated with respective metrics, with the respective metrics comprising action risk metrics; and
selecting one of the action options based, at least in part, on the respective metrics associated with the plurality of action options.

16. The method of claim 15, wherein the multiple input sources comprise one or more of: a video input source, an audio input source, or an RF input source.

17. The method of claim 15, further comprising:
applying at least the selected one of the action options to further train the trainable neural network engine of the each of at least one of the processing columns.

18. A neuromorphic-processing-based autonomous system, the system comprising:
a plurality of processing columns configured to process respective data corresponding to at least one of a plurality of data types, each of the plurality of processing columns comprises a trainable deep neural network engine configured to produce corresponding output; and
a global controller coupled to the plurality of processing columns, the global controller configured to:
receive real-time data from multiple input sources, each of the multiple input sources respectively associated with one of the plurality of data types;
direct data associated with the plurality of data types to the respective ones of the plurality of processing columns;
fuse outputs from the processing columns to generate a plurality of action options representative of actions performable by the autonomous system, each of the action options associated with respective metrics, with the respective metrics comprising action risk metrics; and
select one of the action options based, at least in part, on the respective metrics associated with the plurality of action options.

19. The system of claim 18, wherein the multiple input sources comprise one or more of: a video input source, an audio input source, or an RF input source.

20. The system of claim 19, further comprising one or more of: a video input sensor to generate video data provided to the video input source, an audio sensor to generate audio data provided to the audio input source, or an RF receiver to receive RF data provided to the RF input source.
